(19) United States
(12) Patent Application Publication
(10) Pub. No.: US 2025/0319743 A1
(43) Pub. Date: Oct. 16, 2025

(54) HEATING, VENTILATING, AND AIR CONDITIONING SYSTEM FOR VEHICLE AND METHOD OF CONTROLLING SAME

(71) Applicants: Hyundai Motor Company, Seoul (KR); Kia Corporation, Seoul (KR); DOOWON CLIMATE CONTROL CO.,LTD, Asan-si (KR)

(72) Inventors: Uug Hwi KIM, Hwaseong-si (KR); Gee Young SHIN, Suwon-si (KR); Sang Yeop LEE, Suwon-si (KR); Jae Woo LEE, Hwaseong-si (KR); Young Tae SONG, Gwangmyeong-si (KR); Seung Won JUNG, Hwaseong-si (KR); Hong Re JO, Sejong-si (KR); Se Youn OH, Anseong-si (KR)

(21) Appl. No.: 18/937,229

(22) Filed: Nov. 5, 2024

(30) Foreign Application Priority Data
Apr. 15, 2024 (KR) 10-2024-0049994

(51) Int. Cl. B60H 1/00

(52) U.S. Cl. CPC B60H 1/00835; B60H 1/00064; B60H 1/00742; B60H 2001/002

(57) ABSTRACT

An HVAC system for a vehicle is configured to draw air from an air inlet, to condition the drawn air, and to discharge the conditioned air to at least one discharge portion in the vehicle through a main flow path. The HVAC system includes a bypass flow path configured to connect a first side of the main flow path disposed at a side of the at least one discharge portion to a second side of the main flow path disposed at a side of the air inlet. The bypass flow path is configured to allow or block a flow of air through the bypass flow path.

### CROSS REFERENCE TO RELATED APPLICATION

The present application claims priority to Korean Patent Application No. 10-2024-0049994, filed on Apr. 15, 2024, the entire contents of which are incorporated herein for all purposes by this reference.

### TECHNICAL FIELD

The present disclosure relates to a heating, ventilating, and air conditioning (HVAC) system for a vehicle.

### BACKGROUND

A vehicle may include a heating, ventilating, and air conditioning (HVAC) system to maintain the air in a vehicle cabin in a proper state. The HVAC system may provide the interior of the vehicle with an environment with appropriate temperature and humidity by drawing in air and controlling the temperature and humidity of the air drawn in through an evaporator or heater. In some examples, the air may be indoor or outdoor air. For example, the HVAC system may operate in an outside air circulation mode in which outside air flowing in from outside the vehicle is drawn in and circulated, or in an inside air circulation mode in which air circulating inside the vehicle is drawn in and recirculated.

When heating with a heater in the inside air circulation mode, the HVAC system has a limit on the amount of air intake to prevent moisture from forming on the vehicle's windows. Additionally, during heating, the HVAC system may solely draw air from inside the vehicle cabin, thus causing its fast heat-up ability to be reduced.

### SUMMARY

The present disclosure describes an HVAC system and a method of controlling the same that may improve the fast heat-up ability of a vehicle cabin.

In addition, the present disclosure describes an HVAC system and a method of controlling the same that may improve the heating efficiency.

According to one aspect of the subject matter described in this application, an HVAC system for a vehicle is configured to draw air from an air inlet, to condition the drawn air, and to discharge conditioned air to at least one discharge portion in the vehicle through a main flow path. The HVAC system may include a bypass flow path configured to connect the main flow path on a side of the at least one discharge outlet with the main flow path on a side of the air inlet. A flow of air through the bypass flow path may be configured to be allowed or blocked.

According to another aspect, a method of controlling an HVAC system may include detecting, by a sensor, whether a seat in a vehicle is unoccupied and in response to determining that the seat is unoccupied, directing, by a controller, air in a main flow path flowing toward the seat that is unoccupied by the HVAC system of the vehicle toward an air inlet of the HVAC system.

In some implementations, an HVAC system and a method of controlling the same that may improve the fast heat-up ability of a vehicle cabin are provided.

In some implementations, an HVAC system and a method of controlling the same that may improve the heating efficiency are provided.

The effects of the present disclosure are not limited to those described above, and other effects not mentioned can be clearly recognized by those skilled in the art from the description below.

### BRIEF DESCRIPTION OF THE DRAWINGS

The above and other objectives, features, and other advantages of the present disclosure will be more clearly understood from the following detailed description when taken in conjunction with the accompanying drawings.

FIG. 1 is a diagram showing an example of a vehicle including an HVAC system.

FIGS. 2 and 3 are each perspective views showing the HVAC system.

FIG. 4 is a cutaway view taken along line V1-V1 in FIG. 3.

FIG. 5 is a sectional view of the HVAC system.

FIG. 6 is a view showing an example of a first bypass flow path of the HVAC system.

FIG. 7 is a view showing an example of a bypass flow path of the HVAC system.

FIGS. 8A and 8B are views showing examples of closed and open states, respectively, of the bypass flow path of the HVAC system.

FIG. 9A is a view showing the open or closed state of the bypass flow path of the HVAC system when a front passenger seat of the vehicle is unoccupied.

FIG. 9B is a view showing the open or closed state of the bypass flow path of the HVAC system when a rear seat of the vehicle is unoccupied.

FIG. 9C is a view showing the open or closed state of the bypass flow path of the HVAC system when the front passenger seat and rear seat of the vehicle are unoccupied.

FIG. 9D is a view showing the open or closed state of the bypass flow path of the HVAC system when both the front passenger seat and the rear seat of the vehicle are occupied.

FIG. 10 is an example of a control flow diagram of the HVAC system.

### DETAILED DESCRIPTION

Specific structural and functional descriptions described in implementations of the present disclosure are exemplified merely for the purpose of explaining the implementations according to a concept of the present disclosure, and the implementations according to the concept of the present disclosure may be implemented in various forms. In addition, the disclosure should not be construed to be limited by the implementations described in the present disclosure and should be understood to include all modifications, equivalents, or substitutes included in the spirit and technical scope thereof.

Like reference numbers indicate like elements throughout the present specification.

Below, the present disclosure will be described in detail with reference to the accompanying drawings.

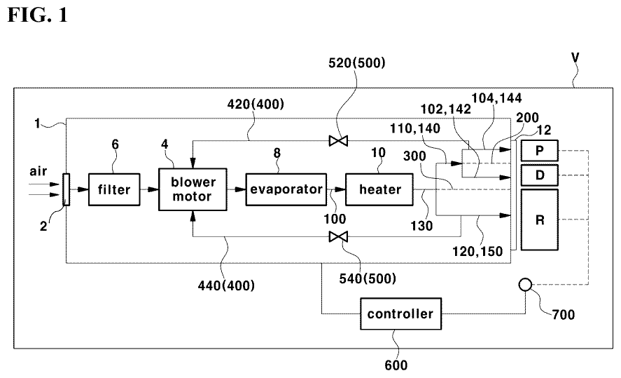

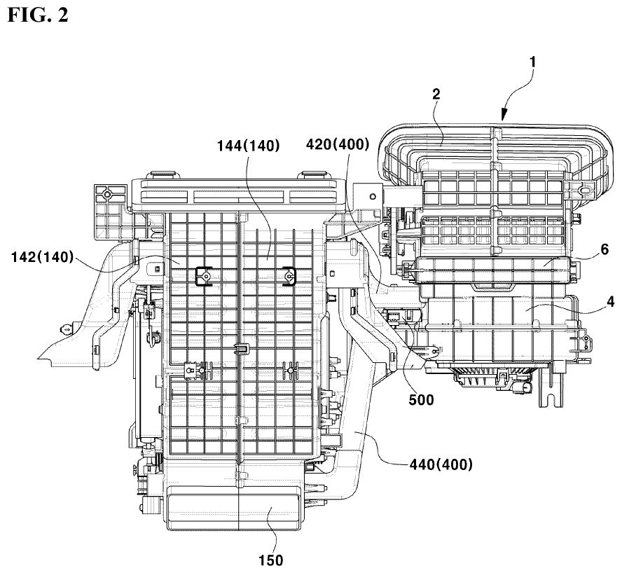

As shown in FIGS. 1 and 2, a vehicle V includes a heating, ventilating, and air conditioning (HVAC) system 1.

In some implementations, the HVAC system 1 may draw air through an air inlet 2. The air inlet 2 may be indoor air circulating inside a vehicle cabin or outside air from outside the vehicle cabin. The air may be drawn by a blower motor 4 of the HVAC system 1. Additionally, a filter 6 may be disposed between the air inlet 2 and the blower motor 4. The filter 6 is configured to filter the drawn air.

The HVAC system 1 may condition the drawn air so as to maintain the air in the vehicle cabin of the vehicle V in an appropriate state and circulate the conditioned air through the interior of the vehicle V. For example, the HVAC system 1 may include an evaporator 8 and a heater 10. The evaporator 8 may lower the temperature or control the humidity of the drawn air. The evaporator 8 may be disposed on a refrigerant circuit in which refrigerant circulates and may cause the refrigerant and the drawn air to exchange heat. The heater 10 may heat the drawn air to raise its temperature and provide warm air into the interior of the vehicle.

The HVAC system 1 includes one or more air outlets 12. The one or more air outlets 12 may be provided at a set location in the vehicle V to discharge the conditioned air through the air outlet 12 placed inside or outside the vehicle.

In some implementations, the HVAC system 1 includes a main flow path 100. The drawn air may flow along the main flow path 100, and the main flow path 100 is configured to extend from the air inlet 2 to the air outlet 12. The evaporator 8 and heater 10 are disposed on the main flow path 100.

In some examples, the main flow path 100 may include one or more discharge portions 130. The one or more discharge portions 130 may include a front seat discharge portion 140 that discharges air toward the front seats (D, P) of the vehicle and a rear seat discharge portion 150 that discharges air toward a rear seat (R) of the vehicle. In the present specification, the discharge portion 130 may be used to include the air outlet 12 and the surrounding area of the air outlet 12. For example, the discharge portion 130 may refer to an upstream part of the air outlet 12 with respect to a direction of a flow of air in the main flow path 100. In another example, the discharge portion 130 may refer to the air outlet 12 itself.

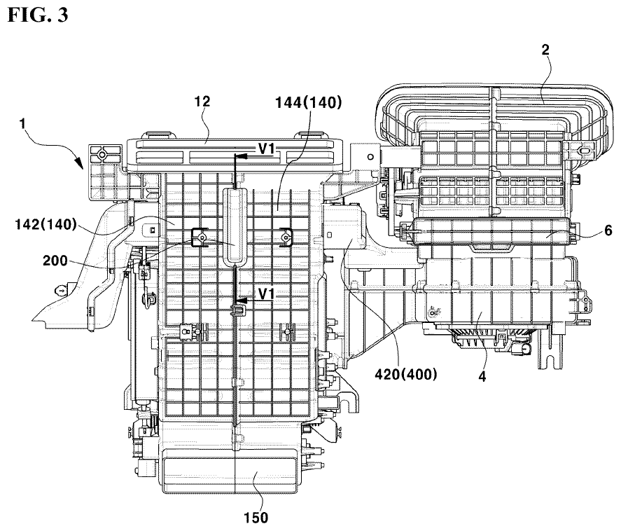

As shown in FIGS. 3 to 4, in some implementations, the front seat discharge portion 140 may include a first screen member 200. The first screen member 200 may separate the main flow path 100 extending toward a side of the front seat of the vehicle V into a first flow path 102 that discharges air toward a side of the driver seat (D) and a second flow path 104 that discharges air toward a side of the front passenger seat (P). A driver seat discharge portion 142 may be provided in the first flow path 102, and the front passenger seat discharge portion 144 may be provided in the second flow path 104. Therefore, the flow of air through the first flow path 102 and the flow of air through the second flow path 104 at the front seat discharge portion 140 may be independent.

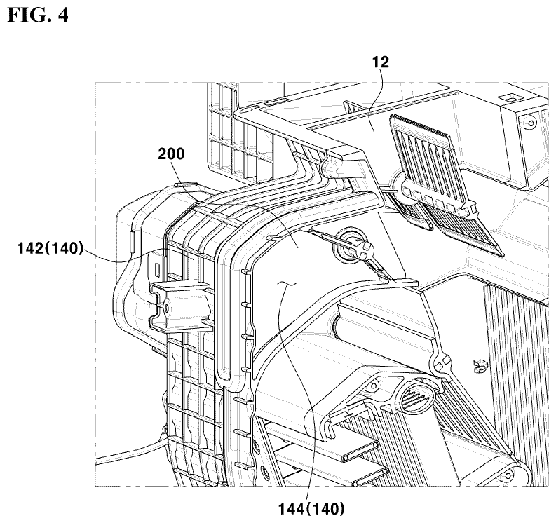

With reference to FIG. 5, in some implementations, the main flow path 100 may include a second screen member 300. The second screen member 300 may be disposed such that the front seat discharge portion 140 and the rear seat discharge portion 150 may be branched off on the main flow path 100. The main flow path 100 may be divided into a first main flow path 110 and a second main flow path 120 upstream of the second screen member 300 by the second screen member 300. By the second screen member 300, the air passing through the first main flow path 110 and the air passing through the second main flow path 120 may flow independently from each other.

The first screen member 200 and the second screen member 300 may minimize the influence with respect to other discharge portions when the air discharged through the discharge portion 130 is redrawn through the bypass flow path 400 which will be described later.

In some implementations, the HVAC system 1 includes the bypass flow path 400.

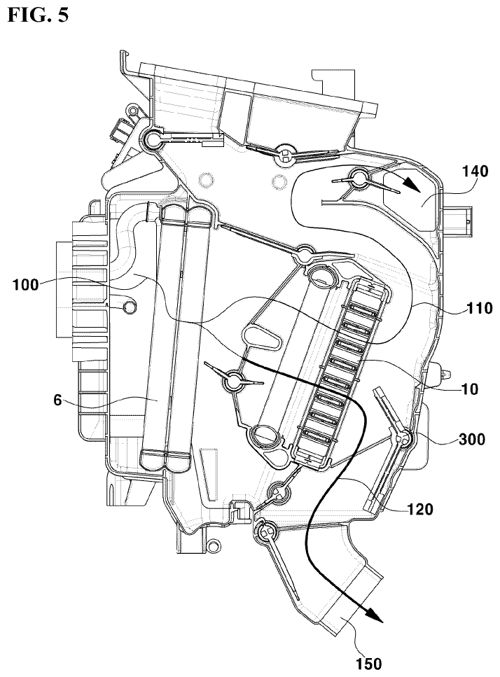

As shown in FIG. 6, the bypass flow path 400 may include a first bypass flow path 420. The first bypass flow path 420 may connect the front passenger seat discharge portion 144 of the front seat discharge portion 140 and the main flow path 100 on a side of the air inlet 2. In some implementations, the first bypass flow path 420 may directly connect the front passenger seat discharge portion 144 and the air inlet 2. In some implementations, the first bypass flow path 420 may connect the front passenger seat discharge portion 144 and the blower motor 4 and, for example, directly connect them. In some implementations, the first bypass flow path 400 may connect the front passenger seat discharge portion 144 and the filter 6 or connect the front passenger seat discharge portion 144 and a downstream part of the filter 6.

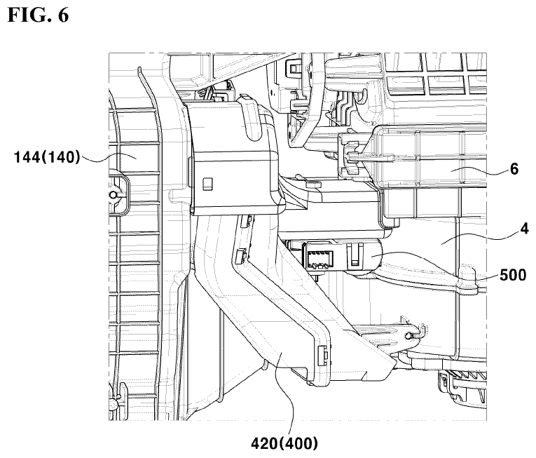

As shown in FIG. 7, the bypass flow path 400 may include a second bypass flow path 440. In some implementations, the second bypass flow path 440 may connect the rear seat discharge portion 150 and the air inlet 2. In some implementations, the second bypass flow path 440 may directly connect the rear seat discharge portion 150 and the air inlet 2. In some implementations, the second bypass flow path 440 may connect the rear seat discharge portion 150 and the blower motor 4 and, for example, directly connect them. In some implementations, the second bypass flow path 440 may connect the rear seat discharge portion 150 and the filter 6 or connect the rear seat discharge portion 150 and a downstream part of the filter 6.

In some implementations, the bypass flow path 400 may be directly connected to the blower motor 4, thereby minimizing heat loss. In some implementations, the bypass flow path 400 may be connected between a downstream part of the filter 6 and the blower motor 4. This may prevent a problem in that the filter 6 is exposed to hot air during reintake through the bypass flow path 400 to cause humidity or odor to be redistributed.

The flow of air through the bypass flow path 400 may be allowed or blocked. For example, in some implementations, a controllable valve 500 may be disposed in the bypass flow path 400.

The valve 500 may include a first valve 520. The position of the first valve 520 may be adjusted to allow or block the flow of air through the first bypass flow path 420.

In addition, the valve 500 may include a second valve 540. The position of the second valve 540 may be adjusted to allow or block the flow of air through the second bypass flow path 440.

The valve 500 may be controlled by a controller 600. According to one implementation of the present disclosure, the controller 600 may be a controller of the HVAC system 1. The controller of the HVAC system 1 may control the operation of the HVAC system 1. In one implementation, the controller of the HVAC system 1 may control the operation of at least some of the blower motor 4, the evaporator 8, or the heater 10 based on the needs of vehicle occupants. In another implementation of the present disclosure, the controller 600 may be a separate controller provided independently from the controller of the HVAC system 1. The separate controller may include one or more controllers and may be configured to control the operation of the valve 500.

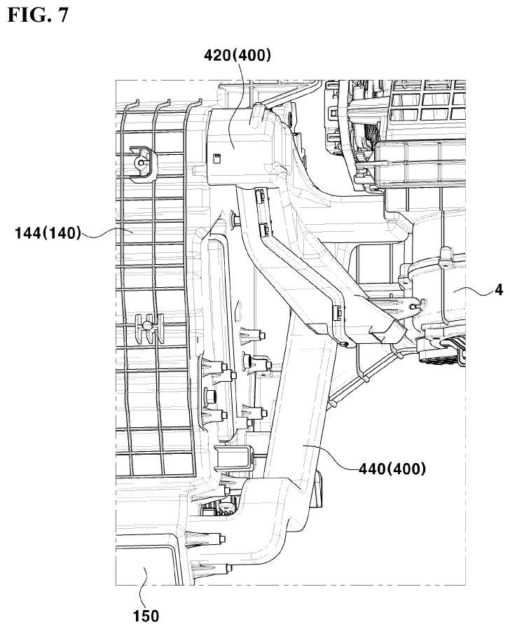

With reference to FIGS. 8A and 8B, in some implementations of the present disclosure, a door 501 and an actuator 503 may be disposed in the bypass flow path 400. The door 501 and the actuator 503 may function like the valve 500. Specifically, the actuator 503 may be open or close the door 501. As a non-limiting example, the actuator 503 may include an electric motor or a cylinder.

The door 501 may be disposed at the inlet 3 in communication with the blower motor 4. In one example, the inlet 3 may be provided between the blower motor 4 and the filter 6. As shown in FIG. 8A, the door 501 may block the flow of air to be redrawn into the blower motor 4 through the inlet 3. In addition, when the door 501 is opened by the operation of the actuator 503, as shown in FIG. 8B, the door 501 may allow the flow of air that is redrawn into the blower motor 4 through the inlet 3.

The controller 600 is configured to communicate with a sensor 700. The sensor 700 may detect whether a seat in the vehicle V is occupied. As a non-limiting example, the sensor 700 may be a Seat Belt Reminder (SBR) sensor.

The controller 600 may control the position of the valve 500 or the door 501 based on information detected by the sensor 700. Since the valve 500 and the door 501 operate similarly, using the valve 500 as an example, the open or closed state of the bypass flow path 400 will be described below.

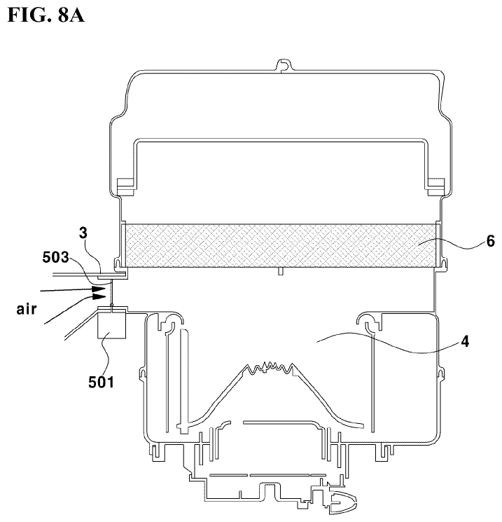

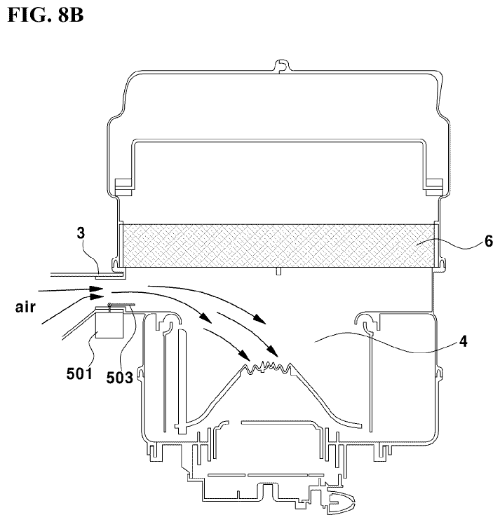

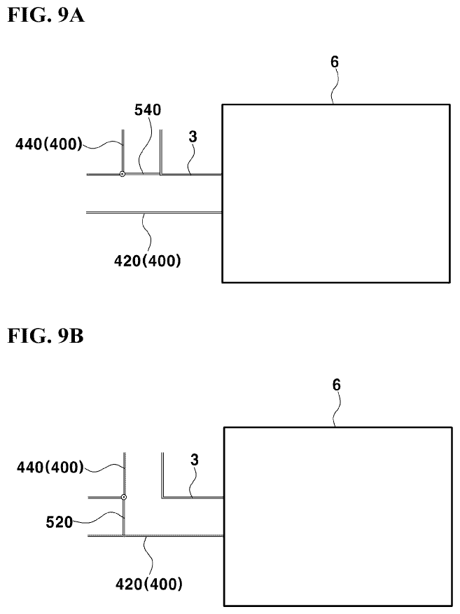

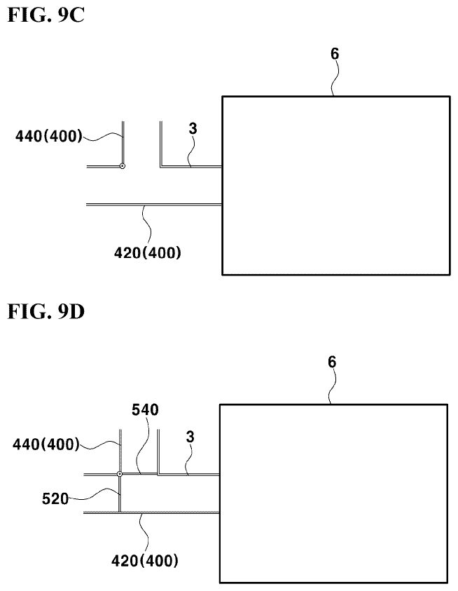

As shown in FIG. 9A, when the sensor 700 detects that the front passenger seat (P) is unoccupied and the rear seat is occupied, the controller 600 may open the first valve 520. By the opening the first valve 520, the air directed toward the front passenger seat (P) through the front passenger seat discharge portion 144 is redirected toward the side of the air inlet 2. In some examples, the side of the air inlet 2 may refer to an upstream part of the blower motor 4. Through this, the high-temperature air that is lost when discharged to a position of an unoccupied seat is guided to be directed again to the blower motor 4, thereby increasing the fast heat-up ability.

In one implementation, as shown in FIG. 9B, when the sensor 700 detects that the rear seat (R) is unoccupied, the controller 600 may open the second valve 540. Through this, the air to be supplied to the rear seat (R) may be redirected toward the side of the air inlet 2.

As shown in FIG. 9C, in one implementation, when the sensor 700 detects that both the front passenger seat (P) and the rear seat (R) are unoccupied, the controller 600 may open both the first valve 520 and the second valve 540. In this case, the air to be supplied to each of the front passenger seat (P) and the rear seat (R) may be redirected toward the side of the air inlet 2.

As shown in FIG. 9D, in one implementation, when the sensor 700 detects that both the front passenger seat (P) and the rear seat (R) are occupied, the controller 600 may dispose both the first valve 520 and the second valve 540 in a closed position. Therefore, when there is a passenger in the front passenger seat (P) or the rear seat (R), heating may be provided to the corresponding seat as well.

Put differently, as shown in FIGS. 9B and 9D, when the sensor 700 detects that the front passenger seat (P) of the front seats (D and P) is occupied, the controller 600 may put the first valve 520 in the closed position.

In addition, as shown in FIGS. 9A and 9D, in one implementation, when the sensor 700 detects that the rear seat (R) is occupied, the controller 600 may adjust the position of the second valve 540 to close the second valve 540.

When the air to be discharged through the discharge portion 130 is redirected into the air inlet 2 by the bypass flow path 400, the drawing force of the blower motor 4 and the force by which the wind is discharged through the discharge portion 130 may be added so that the amount of ventilation in the bypass flow path 400 may increase to an extent of affecting other discharge portions 130. According to the present disclosure, the above problem may be solved by the introduction of the first screen member 200 which allows the independent flows of air through the driver seat discharge portion 142 and the front passenger seat discharge portion 144, respectively, and/or the second screen member 300 which allows the independent flows of air through the front seat discharge portion 140 and the rear seat discharge portion 150, respectively.

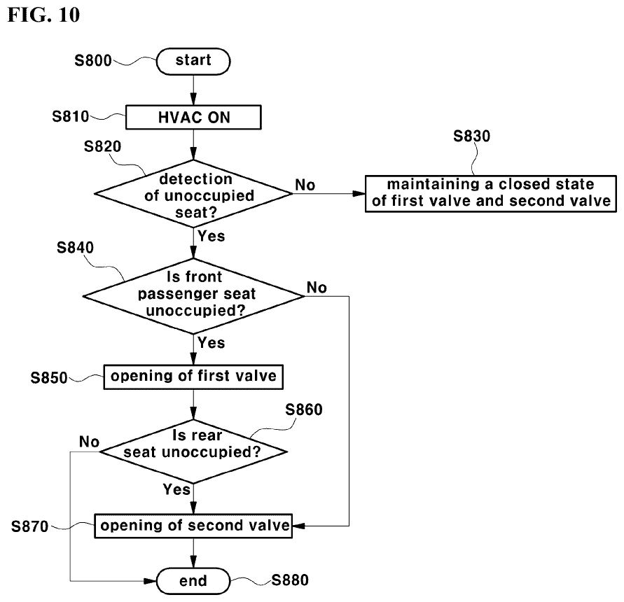

According to some implementations of the present disclosure, the HVAC system 1 may be controlled by a flow diagram as shown in FIG. 10.

The control of the HVAC system 1 starts at operation S800. The controller 600 recognizes that the HVAC system 1 is turned on at operation S810. The sensor 700 is configured to detect, at operation S820, whether an unoccupied seat is present among the seats of the vehicle V. When no unoccupancy is detected at operation S830, that is, when it is detected that all seats in the vehicle are occupied by passengers, the sensor 700 transmits the detected information to the controller 600. The controller 600 is configured to maintain a closed state of the first valve 520 and the second valve 540 based on the information received from the sensor 700 at operation S830. Accordingly, the HVAC system 1 is configured not to redraw the wind discharged toward the front passenger seat (P) and/or the rear seat (R).

When the sensor 700 detects a position where a seat is unoccupied at operation sS840, the controller 600 determines whether the front passenger seat (P) corresponds to the position where a seat is unoccupied based on the information detected by the sensor 700. When the front passenger seat (P) is determined to correspond to the position where a seat is unoccupied, the controller 600 is configured to open the first valve 520 at operation S850. The high-temperature air to be discharged to the front passenger seat (P) may be redrawn through the first bypass flow path 420 by opening the first valve 520 and may be directed toward the air inlet 2 or a side of the blower motor 4. When the front passenger seat (P) is determined not to correspond to the position where a seat is unoccupied, the controller 600 determines that the rear seat (R) corresponds to the position where a seat is unoccupied and opens the second valve 540. When the second valve 540 is opened, the high-temperature wind to be discharged to the rear seat (R) is redrawn through the second bypass flow path 440, and the redrawn air may be directed toward the air inlet 2 or the side of the blower motor 4.

After opening the first valve 520, the controller 600 is configured to determine whether the rear seat (R) is also unoccupied at operation S860. When it is determined that the rear seat (R) is occupied, the controller 600 ends control at operation S880. When the rear seat (R) is also determined to be unoccupied, the controller 600 is configured to open the second valve 540 at operation S870. By the opening of the second valve 540, high-temperature air may be redrawn toward the air inlet 2 or the side of the blower motor 4 through the second bypass flow path 440, along with the first bypass flow path 420.

In the shown implementation, it is first determined whether the front passenger seat (P) is unoccupied, but this is only one implementation. In other words, it may be first determined whether the rear seat (R) is unoccupied, and it may also be determined at the same time whether the front passenger seat (P) is unoccupied and whether the rear seat (R) is unoccupied.

In addition, in the present specification, the front passenger seat and the rear seat are described as examples, but this is only for the purpose of enabling those skilled in the art to clearly understand the present disclosure. That is, it will be clearly understood by those skilled in the art that the present disclosure may be applied to a vehicle with more or fewer seats in addition to a vehicle with other seats including a front passenger seat and a rear seat.

Therefore, the present disclosure may minimize heat or air volume loss wasted in a position where a seat is unoccupied in a vehicle including various seat arrangements, thereby improving heating performance.

The present disclosure may increase fast heat-up ability by re-suction high-temperature air to be discharged to a position where a seat is unoccupied into the blower motor.

In addition, the present disclosure may improve fast heat-up ability and energy efficiency because it is driven according to vehicle riding conditions without separate operations.

The present disclosure may directly connect the bypass flow path to the blower motor to minimize heat loss and minimize the generation of window moisture due to breathing compared to the conventional air intake method through a blower motor.

In addition, since the present disclosure has a small influence with respect to other discharge portions by the introduction of the screen members, it is possible to recirculate hot air at a high volume, thereby improving the fast heat-up ability.

The present disclosure described above is not limited to the above-described implementations and the accompanying drawings, and it will be obvious to those skilled in the art that various substitutions, modifications, and changes are possible without departing from the technical spirit of the present disclosure.

What is claimed is:

1. A heating, ventilating, and air conditioning (HVAC) system for a vehicle, the HVAC system being configured to draw air from an air inlet, to condition the drawn air, and to discharge the conditioned air to at least one discharge portion in the vehicle, the HVAC system comprising:
a main flow path configured to provide the conditioned air toward the at least one discharge portion in the vehicle; and
a bypass flow path configured to connect (i) a first side of the main flow path disposed at a side of the at least one discharge portion to (ii) a second side of the main flow path disposed at a side of the air inlet, the bypass flow path being configured to allow or block a flow of air through the bypass flow path.

2. The HVAC system of claim 1, further comprising:
a controllable valve configured to allow or block the flow of air through the bypass flow path.

3. The HVAC system of claim 2, further comprising:
a sensor configured to detect whether a seat of the vehicle toward which the air through the at least one discharge portion is directed is occupied; and
a controller configured to communicate with the sensor and to adjust a position of the controllable valve based on information detected by the sensor.

4. The HVAC system of claim 3, wherein the controller is configured to open the controllable valve in response to the sensor detecting that the seat is unoccupied.

5. The HVAC system of claim 3, wherein the controller is configured to close the controllable valve in response to the sensor detecting that the seat is occupied.

6. The HVAC system of claim 1, further comprising a blower motor configured to draw air from the air inlet,
wherein the bypass flow path is configured to connect the at least one discharge portion to one of the blower motor or a portion of the main flow path that is disposed upstream relative to the blower motor in a flow direction of the drawn air.

7. The HVAC system of claim 1, wherein the bypass flow path comprises:
a first bypass flow path that is configured to connect (i) a first portion of the main flow path that is directed toward front seats of the vehicle to (ii) the second side of the main flow path disposed at the side of the air inlet.

8. The HVAC system of claim 7, further comprising:
a first screen member configured to divide the first portion of the main flow path directed toward the front seats of the vehicle into (i) a first flow path directed toward a driver seat and (ii) a second flow path directed toward a front passenger seat,
wherein the first bypass flow path is configured to connect the second flow path to the second side of the main flow path disposed at the side of the air inlet.

9. The HVAC system of claim 7, wherein the bypass flow path further comprises:
a second bypass flow path configured to connect (i) a second portion of the main flow path that is directed toward a rear seat of the vehicle to (ii) the second side of the main flow path disposed at the side of the air inlet.

10. The HVAC system of claim 1, wherein the main flow path comprises:
a first main flow path directed toward front seat discharge portions of the vehicle that are configured to discharge the air toward front seats of the vehicle;
a second main flow path directed toward a rear seat discharge portion of the vehicle that is configured to discharge the air toward a rear seat of the vehicle; and
a second screen member configured to separate the first main flow path and the second main flow path from each other.

11. The HVAC system of claim 10, wherein the bypass flow path comprises:
a first bypass flow path configured to connect one of the front seat discharge portions to the second side of the main flow path that is disposed at the side of the air inlet; and
a second bypass flow path configured to connect the rear seat discharge portion to the second side of the main flow path disposed at the side of the air inlet.

12. The HVAC system of claim 1, further comprising:
a heater disposed at the main flow path and configured to increase a temperature of the drawn air to a preset temperature.

13. A vehicle comprising an HVAC system according to claim 1.

14. A method for controlling a heating, ventilating, and air conditioning (HVAC) system of a vehicle, the HVAC system including an air inlet and a main flow path, the main flow path being configured to provide air toward a seat of the vehicle, the method comprising:
detecting, by a sensor, whether the seat of the vehicle is unoccupied; and
in response to determining that the seat that is unoccupied, directing, by a controller, air in the main flow path toward the air inlet of the HVAC system.

15. The method of claim 14, wherein the HVAC system further includes a bypass flow path configured to connect (i) a discharge portion of the main flow path directed toward the seat to (ii) a portion of the main flow path that is disposed at a side of the air inlet of the HVAC system, and
wherein directing the air toward the air inlet comprises allowing a flow of the air through the bypass flow path.

16. The method of claim 15, wherein directing the air toward the air inlet comprises:
controlling, by the controller, a position of a valve that is configured to allow or block the flow of the air through the bypass flow path.

17. The method of claim 15, further comprising:
in response to the sensor detecting that the seat is occupied, blocking, by the controller, the flow of the air through the bypass flow path.

18. The method of claim 15, wherein the bypass flow path includes:
a first bypass flow path configured to connect one of front seat discharge portions of the vehicle to the portion of the main flow path disposed at the side of the air inlet;
a first valve configured to allow or block a flow of air through the first bypass flow path;
a second bypass flow path configured to connect a rear seat discharge portion of the vehicle to the portion of the main flow path disposed at the side of the air inlet; and
a second valve configured to allow or block a flow of air through the second bypass flow path.

19. The method of claim 18, further comprising:
in response to the sensor detecting that front seats of the vehicle are unoccupied, opening, by the controller, the first valve.

20. The method of claim 18, further comprising:
in response to the sensor detecting that a rear seat of the vehicle is unoccupied, opening, by the controller, the second valve.
